(19) United States
(12) Patent Application Publication
(10) Pub. No.: US 2004/0213659 A1
(43) Pub. Date: Oct. 28, 2004

(54) Process and device for transferring plate-shaped articles, especially panes of glass

(75) Inventor: Peter Lisec, Amstetten-Hausmening (AT)

Correspondence Address: YOUNG & THOMPSON, 745 SOUTH 23RD STREET 2ND FLOOR, ARLINGTON, VA, 22202

(73) Assignee: TECNOPAT AG, ST. GALLEN (CH)

(21) Appl. No.: 10/821,844

(22) Filed: Apr. 12, 2004

(30) Foreign Application Priority Data
Apr. 11, 2003 (EP) 03008388.5

(51) Int. Cl. B25J 1/00

(52) U.S. Cl. 414/754

(57) ABSTRACT

In order to allow a glass plate (26) to fall over out of the position which is tilted somewhat to the vertical into an essentially horizontal position, the glass pane (26) standing up with its lower edge (28) on the conveyor device (22) and with its upper edge (29) resting against a support member (40) with rollers (44) is moved into the initial position. By moving the support member (40) away from the upper edge (29) of the glass pane (26) it is allowed to fall down to the rear so that it comes to rest on the support surface of the table (2). From this support surface which can be made as an air cushion or as a span with transport belts or rollers, a glass pane (26) which points up with its “nicer” side (27) can be delivered to further treatment, for example to a downstream device (18).

The invention relates to a process and a device for transfer of plate-shaped articles. In particular the invention considers the transfer of panes of glass from a position which is tilted “to the rear” relative to vertical by a few degrees (for example 5°), therefore in an essentially vertical position, into an essentially horizontal position.

This transfer of plate-shaped elements, such as panes of glass, is carried out in the glass industry mainly using tilting tables. These tilting tables are comparatively complex in structure and after each transfer of a glass pane must be raised again into a horizontal position in order to be correctly aligned for the transfer of another glass plate. Therefore the known tilting tables also work slowly (long cycle times).

In the glass industry, transferring panes of glass by allowing them to “fall over” from an essentially vertical position into a horizontal position on a support surface is also known.

The problem in known devices is that they hold the panes of glass with an essentially vertical alignment, in which they come to be for example in a glass magazine, then the panes of glass swivel out of this oblique position via an exactly vertical position into the opposite oblique position and are then allowed to fall over. This manner of operation is necessary when glass panes have a “nicer” front (for example with a coating) and a less “nice” back. In systems for preparation of panes of glass, such as glass washing machines, glass magazines, and the like the glass panes are aligned such that the “nice” side is aligned such the they are not touched by the transport means or grippers which hold the panes of glass. This applies especially to glass panes provided with a metal coating. These glass panes should come to rest such that their “nicer” side then points up.

The object of the invention is to devise a process and a device of the initially mentioned type which can be executed easily and without major construction effort and still enables careful and prompt transfer of glass panes.

This object is achieved as claimed in the invention with a process which has the features of claim 1.

Preferred and advantageous embodiments of the process as claimed in the invention are the subject manner of the dependent process claims.

To the extent the device is affected, the object as claimed in the invention is achieved with a device which has the features of the independent main apparatus claim.

Preferred and advantageous embodiments of the device as claimed in the invention are the subject matter of the dependent claims.

In the manner of operation as claimed in the invention the glass pane is allowed to fall over “to the rear”, this means that it falls over toward the side to which it is already (somewhat) tilted relative to the vertical. Here it is advantageous in the invention if the glass pane is aligned such that in the position (initial position) which is slightly titled relative to the vertical the “nicer” side which optionally bears a coating points up so that this side of the transferred glass pane then likewise points up. All this is achieved very easily by the glass pane being allowed to fall over “to the rear”. In the invention therefore it is not generally necessary to raise the glass panes out of the position in which they are tilted to the vertical to one side and only then allowed to fall over onto the other side.

In particular in the invention it is possible to proceed such that the glass sheet, at the bottom standing upright on a conveyor belt and at the top adjoining a support means which is optionally equipped with a row of rollers, is moved into the initial position from which it is then allowed to fall over.

In the manner of operation as claimed in the invention, the conveyor device, on which the glass sheet stands upright with its lower edge, can be moved essentially perpendicular to the track of the glass pane (lower edge). By this measure the glass pane can be aligned in the initial position relative to the support surface onto which the glass pane is allowed to fall over, such that the glass panes, after they have fallen over, come to rest on the support surface independently of their size in a predefinable position and are aligned. Thus it is possible to take into account the circumstance that larger glass panes, after they have fallen over, continue to slide a distance in the direction of falling on the support surface, this distance being greater than the distance by which smaller glass panes slide. To keep constant the oblique position from which the glass pane is allowed to fall over, even when the lower conveyor device is moved, the support of the upper edge of the glass pane can likewise be adjustable in the horizontal direction.

In order to allow the glass pane to fall, which pane has been moved into the initial position intended for falling, it is sufficient to remove the support from the top edge of the glass pane; this can take place for example by this support being moved away to the top out of the area of the glass pane.

The described possibility for matching the initial position of the glass pane to its size, with the objective that the previously bottom edge of the glass pane after the latter falls over is located on the support surface in a predefinable position is especially advantageous when the glass pane is moved away from the support surface using the conveyor devices, since the glass pane lies in a defined reference position on the support surface. This is especially advantageous when the glass pane is to be conveyed farther from the support surface essentially parallel to the previously (i.e. in the initial position) lower edge of the glass pane.

The support surface can be tiltable, the tilting on the one hand determining the extent of falling of the glass pane (therefore the angle by which the glass pane swivels when allowed to fall). On the other hand, in this way the edge of the support surface facing away from the conveyor device can be aligned such that easy transport of the glass pane into a downstream device is possible, even if it is higher than the support surface.

To the extent the device as claimed in the invention is involved, the transport means on which the lower edge of the glass pane stands is either a row of rollers or a conveyor belt, and the transport means can preferably be adjusted on a guide transversely to the conveyor direction.

The means for supporting the upper edge of the glass pane in the initial position in one embodiment is a row of (freely rotating) rollers or a continuous belt which are located on a beam which is mounted to be vertically adjustable. The rollers or the belt point preferably vertically down from the beam. Any shape of the rollers is possible, conical rollers or cylindrical rollers likewise being considered.

The support means for the upper edge of the glass pane in its initial position can also be horizontally adjustable. In one embodiment this adjustment is synchronized with the adjustment of the lower conveyor device so that the glass pane in the initial position always assumes the same angle to the vertical.

Other details and features of the invention follow from the description of one preferred embodiment below using schematic (not to scale) drawings.

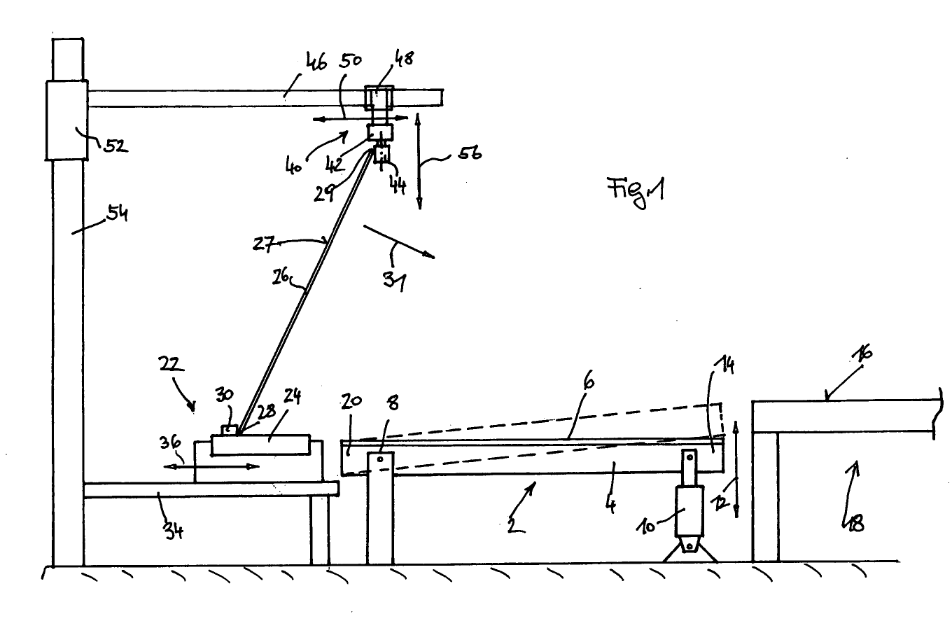

FIG. 1 shows in an oblique view a device as claimed in the invention for free falling of glass panes in order to transfer them out of an essentially vertical position into an essentially horizontal position and

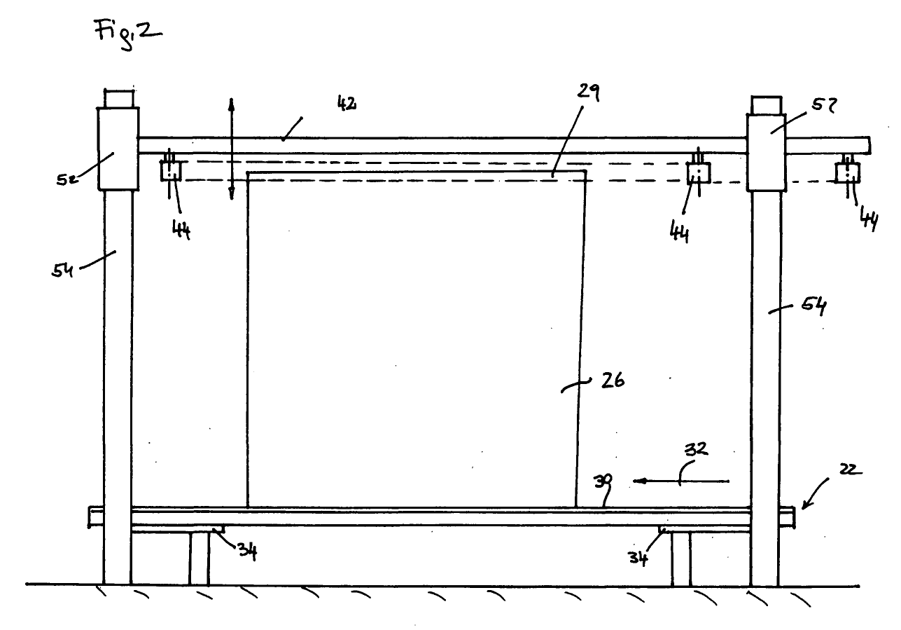

FIG. 2 shows the device from FIG. 1 viewed from the left of FIG. 1.

The device which is shown in FIGS. 1 and 2 for transferring glass panes 26 into an essentially horizontal position has as the support surface a table 2 with a top 4 which has a damping support 6 on its upper side. The damping support 6 can for example be a felt support. The table 2 can be made as an air cushion table in order to facilitate the removal of glass panes transferred onto it away from the table 2. Conveyor means, such as lowerable and raisable conveyor belts or conveyor rollers or drums, can be integrated into the table 2.

The table top 4 on its edge which is the left one in FIG. 1 can be moved around an axis 8 using hydraulic motors 10 in the direction of the double arrow 12 so that the table 2 can be swivelled out of an essentially horizontal position into the tilted position which is shown by the broken line in FIG. 1. In this position the edge 14 of the table top 4 which is the right edge in FIG. 1 is located at essentially the same height as the working surface 16 of a downstream device 18 which is shown in FIG. 1.

Next to the edge 20 of the table 2 which is the left edge in FIG. 1, there is a conveyor device 22. The conveyor device 22 as the conveyor means 24 can have a continuous conveyor belt or rotationally driven rollers. The conveyors means are conceivably also continuous chains with (hook-shaped) supports for glass panes. A glass pane 26 with its lower edge 28 stands up on the conveyor means 24 of the conveyor device 22. A guide 30 prevents the lower edge 28 of the glass pane 26 from migrating transversely to the conveyor direction of the conveyor device 22 (arrow 32 in FIG. 2) when a glass pane 26 is being transported into the device.

The top edge 29 of the glass pane 26 is held by a support means 40. The support means 40 has a beam 42 on which rollers 44 which point down are located. The rollers 44 can turn freely, or if desired, can be equipped with a rotary drive for supporting the transport of the glass panes 26.

The beam 42 in this embodiment is movably guided on an essentially horizontal guide 46 via carriages 48.

The conveyor means 22 can be moved on guides 34 in the direction of the double arrow 36 (FIG. 1). By moving the conveyor device 22- or at least its guide 30—in the direction of the double arrow 36 and optionally in addition moving the support means 40 in the direction of the double arrow 50 a glass pane 26 can be aligned in its initial position 2 shown in FIG. 1 (therefore before it is allowed to fall over) relative to the table 2. In doing so what is important is the alignment of the lower horizontal edge 28 of the glass pane 26 relative to the table 2. The adjustability of the support means 40 in the direction of the double arrow 50 in FIG. 1 is simply an optional and not an absolutely necessary measure. Since the initial position of the glass pane 26 relative to the table 2 can be chosen by moving the transport means 22 and optionally also the support means 40, it is possible to take into account the circumstance that larger glass panes 26 after falling over on the table top 4 slide father, therefore a greater distance, than smaller glass panes 26. Choosing the initial position as a function of the size of the glass pane 26 results in that the glass panes 26, especially their previously lower edge 28, always come to rest on the table 2 in the same position with the lower edge 28 of the glass pane 26, which edge is located at a given site. This facilitates the removal of the glass pane, especially when removal is to take place perpendicularly to the plane of the FIG. 1.

The guides 46 for the carriages 48 of the support 40 are adjustably guided up and down via carriages 52 on vertical guides 54 in the direction of the double arrow 56. This adjustability is used on the one hand to match the support means to the size of the glass pane 26 and on the other to move the support means 40, especially its rollers 44, out of the area of the top edge 29 of the glass plate 26 in order to allow it to fall over in the direction of the double arrow 31, so that it finally comes to rest on the support 6 of the top 4 of the table 2.

Because the conveyor means 22 and optionally the support means 40 are adjustable in the direction of the arrows 36 and 50, therefore essentially transversely to the surface extension of the glass pane 26, the location of the glass pane 26, after it is allowed to fall over in the direction of the arrow 31, can be defined on the table 2 since in this way the circumstance that smaller glass panes 26 on the table 2 “glide” less far than larger glass panes 26 can be taken into account.

The described device can be used for example as follows for executing the process as claimed in the invention:

A glass pane 26 which is transported out of a glass magazine, a washing line or the like, with its lower edge 28 standing up on the conveyor device 22 and with its upper edge 29 adjoining the support 40, especially its rollers 44, is transported in the direction to the arrow 32 into the device. After the glass pane 26, especially its lower edge 28, by the corresponding adjustment of the lower transport means 22 in the direction of the double arrow 36 (optionally the upper support means 40 is also moved in the direction of the double arrow 50) has been aligned relative to the table 2 such that the glass sheet 26, after it is allowed to fall over, assumes the desired position on the table 2, the upper edge 29 of the glass pane 26 is released by lifting the support means 40 and the glass pane 26 falls over in the direction of the arrow 31. It is apparent, especially when looking at FIG. 1, that the glass pane 26 falls over to the rear, the glass pane 26 being aligned such that its “nicer” side 27, therefore the side of the glass pane 26 which optionally bears a coating of metal or the like, points up.

After the glass pane 26 lies on the support 6 of the top 4 of the table 2, it can be removed by conveyor devices which are not shown, for example transport belts or transport rollers countersunk into the support table 2, in the direction of its track which it assumes in the initial position (alignment of the lower edge 28 of the glass pane 26), therefore essentially perpendicular to the plane of FIG. 1. But it is also possible to move the glass pane away from the table 2 in the direction away from the lower conveyor device 22 (therefore transversely to the lower edge 28, i.e. to the right in FIG. 1) in order to move it to a downstream device 18.

If removal of the glass pane 26 transversely to the plane of FIG. 1 is not intended, the guide 54 for the carriages 52 can also be located in the area of the table 2.

In summary, one embodiment of the invention can be described as follows:

In order to allow a glass pane 26 to fall over out of the position which is tilted somewhat to the vertical into an essentially horizontal position, the glass pane 26 standing up with its lower edge 28 on the conveyor device 22 and with its upper edge 29 resting against a support means 40 is moved into the initial position. By moving the support means 40 away from the upper edge 29 of the glass pane 26, it is allowed to fall down to the rear so that it comes to rest on the support surface of the table 2. From this support surface which can be made as an air cushion or as a span with transport belts or rollers, a glass pane 26 which points up with its “nicer” side 27 can be delivered to further treatment, for example to a downstream device 18.

1. Process for transferring glass panes (26) out of an initial position in which the glass pane (16) is slightly tilted relative to the vertical, into an essentially horizontal position, characterized in that the glass pane (26) in the area of its upper edge (29) is supported by a support (40, 44) which lies on the side of the glass pane (26) which points down, and that the glass pane (26) after the support (40, 44) has been moved away out of the area of the upper edge (29) is allowed to fall over onto a support surface (2).

2. Process as claimed in claim 1, wherein the glass pane (26) is allowed to fall over without first aligning it into the vertical position.

3. Process as claimed in claim 1, wherein the glass pane (26) with its lower edge (28) standing up on the conveyor device (22) is moved into the initial position.

4. Process as claimed in claim 1, wherein the glass pane (26) with its upper edge (29) adjoining the support means (40) is moved into the initial position.

5. Process as claimed in claim 1, wherein at least the distance of the lower edge (28) of the glass pane (26) is aligned at a predetermined distance from the support surface (2) on which the glass pane (26) lies after being allowed to fall over.

6. Process as claimed in claim 5, wherein the glass pane (26) with its lower edge is aligned by moving the transport means (22) transversely to the lengthwise extension of the lower edge (28) of the glass pane (26).

7. Process as claimed in claim 1, wherein the glass pane (26) is aligned by moving its upper edge (29) transversely to the lengthwise extension of the upper edge (29).

8. Device for transferring glass panes (26) out of a position which is slightly titled relative to the vertical into an essentially horizontal position, characterized by a support table (2) for glass sheets (26) in their essentially horizontal position, by a conveyor device (22) for the lower horizontal edge (28) of the glass pane (26) and by a support means (40, 44) for the upper edge (29) of the glass pane (26), and the support means (40) for the upper edge (29) of the glass pane (26) for releasing the upper edge (29) can be moved away out of the area of this edge (29).

9. Device as claimed in claim 8, wherein the support means (40) can be raised.

10. Device as claimed in claim 8, wherein the transport means (22) can be moved transversely to the track of the glass pane (26) which is standing in its initial position (lower edge 28 of the pane) (arrow 36).

11. Device as claimed in claim 8, wherein the support means (40) can be moved transversely to the lengthwise extension of the upper edge (29) of the glass pane (arrow 50).

12. Device as claimed in claim 8, wherein the support means (40) for the top edge (29) of the glass pane has a beam (42) which is equipped with rollers (44).

13. Device as claimed in claim 12, wherein the rollers (44) are arranged pointing down from the beam (42).

14. Device as claimed in claim 12, wherein the rollers (44) are freely rotating rollers.

15. Device as claimed in claim 12, wherein the beam (42) can be moved via a carriage (48) in the horizontal direction (arrow 50).

16. Device as claimed in claim 15, wherein the carriages (48) for the beam (42) can be moved on essentially horizontal guides (46).

17. Device as claimed in claim 16, wherein the horizontal guide (46) of the support (40) can be moved via carriages (52) on vertical guides (54).

18. Device as claimed in claim 8, wherein the support surface (2) can be raised at least in the area of its edge (14) away from the conveyor devices (22).

19. Device as claimed in claim 8, wherein the conveyor device (22) has a conveyor belt (24).

20. Device as claimed in claim 8, wherein the conveyor device (22) has a line of rotary drive rollers.

21. Device as claimed in claim 8, wherein the conveyor device (22) can be moved on guides (34) (arrow 36).

22. Device as claimed in claim 8, wherein the conveyor means (22) has a guide (30) for the lower edge (28) of the glass pane (26).

23. Device as claimed in claim 22, wherein the guide (30) can be moved transversely to the conveyor device (22).
